(19) United States
(12) Patent Application Publication
(10) Pub. No.: US 2010/0215793 A1
(43) Pub. Date: Aug. 26, 2010

(54) DEVICE FOR IMPLEMENTING A SOCKET ON AN END OF CROSSCUT PLASTIC PIPES

(76) Inventors: Helmuth Schnallinger, Nitra (SK); Christian Schnallinger, Sarmingstein (AT)

Correspondence Address: COLLARD & ROE, P.C., 1077 NORTHERN BOULEVARD, ROSLYN, NY, 11576, US

(21) Appl. No.: 12/733,467

(22) PCT Filed: Oct. 22, 2008
(86) PCT No.: PCT/AT2008/000383

§ 371 Date: Mar. 3, 2010

(30) Foreign Application Priority Data
Oct. 24, 2007 (AT) A 1731/2007

(51) Int. Cl. B28B 11/08

(52) U.S. Cl. 425/392

(57) ABSTRACT

A device is described for implementing a socket on an end of crosscut plastic pipes (3) having a framework (4), having a transverse conveyor (27) for the plastic pipes (3), having at least two units situated along the transverse conveyor (27) in the framework (4), on the one hand, for heating the pipe ends (2) and, on the other hand, for widening the heated pipe ends (2) to form a socket, the units having jaw tools (16, 17), which externally enclose the pipe ends (2), and which can be fed transversely to the conveyance direction with the aid of actuators (18) mounted in the framework (4), and having at least one tool (7, 8), which is axially insertable into the pipe end (2) for at least one of the units. In order to provide simple conditions for refitting of the device, it is proposed that the units form interchangeable modules (1), which are mounted so they are displaceable in the axial direction in the framework (4), and which comprise mounts (24) for the jaw tools (16, 17), which are detachable from their actuators (18), and comprise all of the particular tools (7, 8) and drives (11, 12) associated with these units, with the exception of the actuators (18) for the jaw tools (16, 17).

### 1. FIELD OF THE INVENTION

The invention relates to a device for implementing a socket on an end of crosscut plastic pipes having a framework, having a transverse conveyor for the plastic pipes, having at least two units, which are situated along the transverse conveyor in the framework, on the one hand, for heating the pipe ends, and on the other hand, for widening the heated pipe ends to form a socket, the units having jaw tools which externally enclose the pipe ends, and which can be fed transversely to the conveyance direction with the aid of actuators mounted in the framework, and having at least one tool which is axially insertable into the pipe end for at least one of the units.

### 2. DESCRIPTION OF THE PRIOR ART

In order to provide thermoplastic pipes with a socket on one end, the pipe ends to be expanded into a socket are firstly heated and then widened, external jaw tools being required for shaping and tools insertable into the pipe ends being required for widening and/or upsetting the heated pipe ends. The heating of the pipe ends to the processing temperature can be performed in one step, but is preferably performed in two steps, and preferably by heating from the inside and from the outside, which requires external heating jaws and heating cartridges for insertion into the pipe end. For mass production, it is necessary to supply the individual plastic pipes one after another to the units for the heating and the widening, which requires a transverse conveyor associated with these units for the plastic pipes, the plastic pipes being conveyed transversely to their longitudinal axis into the particular units with the jaw tools opened, before the actuators for these jaw tools, whether they are tools for heating or shaping, are applied and the tools for the processing of the pipe ends from the interior are inserted in the axial direction into the pipe ends. The plastic pipes are thus heated and widened to form sockets step-by-step. These known devices for socket implementation have the disadvantage, however, of the comparatively large amount of effort for refitting to different pipe and socket dimensions. To increase the throughput, upon the changeover from a large pipe diameter to a small pipe diameter, the available space can be used for the purpose of providing double tools for two pipes having a small diameter instead of the tools for one large pipe diameter, so that twice the number of small-caliber pipes having terminal sockets may be manufactured in approximately equal cycle times, but the refitting to be performed by hand remains costly.

### SUMMARY OF THE INVENTION

The invention is thus based on the object of implementing a device of the type described at the beginning for implementing a socket on an end of crosscut plastic pipes so that rapid refitting to different pipe and socket dimensions can be performed, without having to dispense with plural manufacturing at smaller pipe dimensions.

The invention achieves the stated object in that the units form interchangeable modules which are mounted so they are displaceable in the axial direction in the framework, and which comprise mounts for the jaw tools, which are detachable from their actuators, and, with the exception of the actuators for the jaw tools, comprise all of the particular tools and drives associated with these units.

By providing interchangeable modules, which are mounted so they are displaceable in the framework in the axial direction, the refitting of the device to different pipe and/or socket dimensions can be performed easily and rapidly, without having to accept excess construction effort. Specifically, if the jaw tools are detachably connected to their radial actuators, these actuators may remain in the framework. It must only be ensured that the jaw tools detached from their actuators are appropriately received in a mount associated with the individual modules, in order to be able to ensure the desired refitting with the change of the modules. The individual modules may follow the framework partition predetermined by the largest pipe and/or socket diameter, and may have plural tools within this predetermined partition. Nothing changes in the socket production in the scope of the particular production method used, which requires specific toolsets.

Although the individual preinstalled modules may each be placed on carriages guided in the framework, particularly advantageous design conditions result if the modules themselves are implemented as carriages which are movable in the framework, because in this case the carriages are solely to be removed from their guides and replaced with alternative carriages.

In order to provide advantageous design conditions for the mount of the jaw tools in the individual modules, the mount for the jaw tools can have carriers which are mounted so they are displaceable parallel to the pipe axes and engage in receptacle recesses of the jaw tools. As these carriers are advanced toward the jaw tools, which are retained with the aid of their actuators in a predetermined transfer position, the carriers engage in the receptacle recesses in the jaw tools, which are thus detached from their particular actuators and may subsequently be moved with the particular module out of the framework. In order that the available space can be used well, it suggests itself that the mutual spacing of the carriers measured in the direction of the feed of the jaw tools be selected as equal to the corresponding spacing of the receptacle recesses of the closed jaw tools, so that the space required for the jaw tools in the area of the individual modules corresponds to that for the closed jaw tools.

Because the individual interchangeable modules contain all tools and their drives for the pipe processing, with the exception of the actuators for the jaw tools, these tools and drives must also be correspondingly activated and supplied with energy. In order to provide simple connection conditions in this context, the modules may each have a coupling part, which works together with a coupling part associated with the framework, of a plug coupling for the control and supply lines of the tools and their drives of the particular unit. With the aid of these plug couplings, the required connections in the area of the control and supply lines may be performed automatically. The individual modules are to be locked in their usage position within the framework. This locking can advantageously be performed via the plug couplings, namely if the coupling parts of the plug couplings which are associated with the framework are mounted so they are adjustable transversely to the displacement guide of the modules and are provided with locking bolts, which engage in detent recesses in the coupling parts of the modules. With the closing of the plug couplings, the modules are thus also locked in relation to the framework, so that separate measures for fixing the modules in the framework are superfluous.

An adaptation of the transverse conveyor, with the aid of which the pipes are supplied one after another to the individual units, also becomes necessary with the refitting of the units for the heating and widening of the pipe ends for pipes and/or sockets of a different size. The adaptation of this transverse conveyor to different pipe dimensions can be made easier if the transverse conveyor comprises the carriages, which are associated with the individual units and are movable along a transverse guide, and which carry jaw tappets which can be fed to the pipes transversely to the transverse guiding, and if the modules have a mount for the jaw tappets, which are detachable from their actuators. In this case, the jaw tappets to be adapted to the different pipe diameters may be interchanged together with the particular unit via the module formed by this unit. Although separate mounts may be provided in the individual modules for the jaw tappets of the transverse conveyor, particularly simple design conditions result if the carriers penetrate the jaw tools in the receptacle recesses and engage in receptacle recesses of the jaw tappets. Because of this measure, the carriers already provided for the jaw tools of the individual units may also be used for receiving the jaw tappets of the transverse conveyor without having to substantially change the design of the mount with the aid of the carrier.

### BRIEF DESCRIPTION OF THE DRAWING

The subject matter of the invention is shown for exemplary purposes in the drawing. In the figures:

FIG. 1 shows a module for a unit for widening the sockets having the associated framework parts of a device according to the invention in a position extended from the framework in a schematic illustration,

FIG. 2 shows a schematic side view of the modules shown in FIG. 1 after the jaw tools are accepted, and

FIG. 3 shows an illustration of the module corresponding to FIG. 2 in the operating position.

### DESCRIPTION OF THE PREFERRED EMBODIMENT

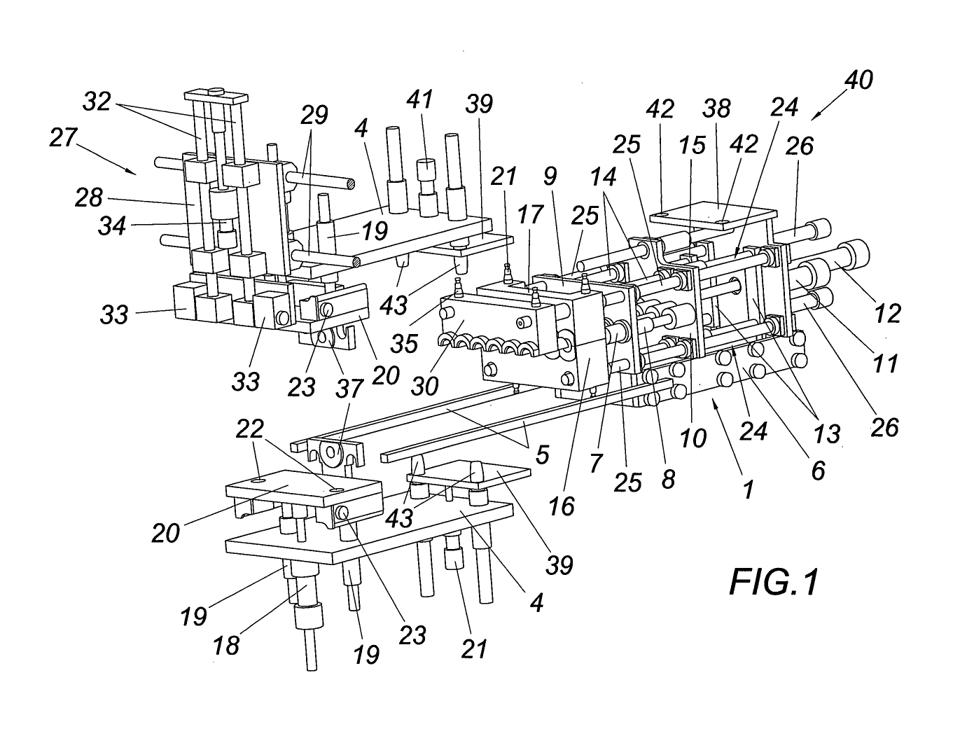

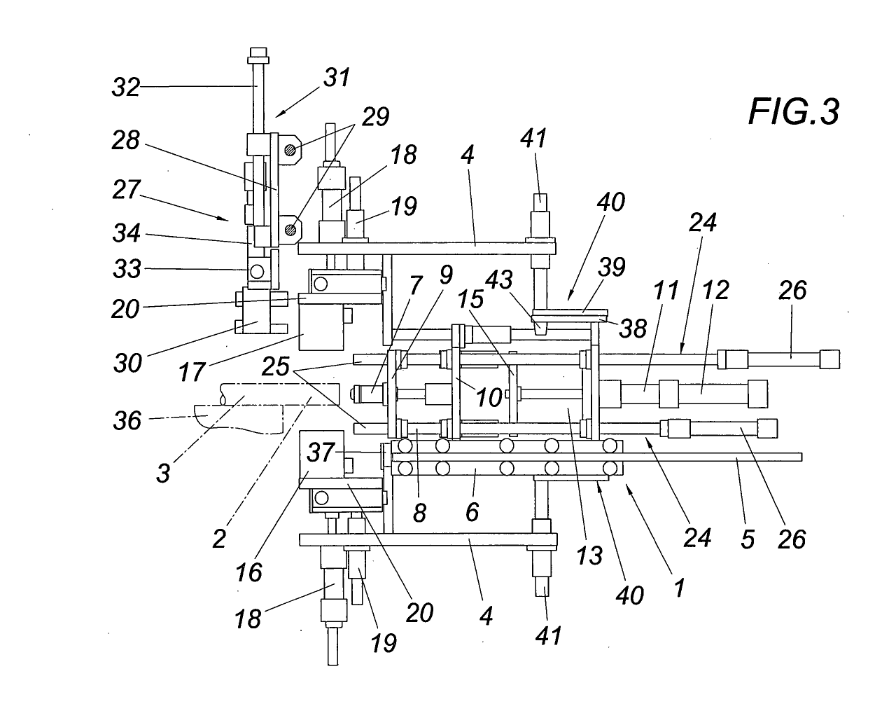

In the device, which is only shown in the area of a module 1 for the widening of the heated pipe ends 2, which are indicated by dot-dash lines in FIG. 3, of the plastic pipes 3, the framework 4 has a displacement guide 5 in the form of slide rails for a carriage 6 formed by the module 1. For the individual plastic pipes 3, which are deformable in one work step, tools 7, 8 for upsetting and/or widening the pipe ends 2 to form sockets widened in relation to the pipe diameter are mounted so they are axially displaceable on this carriage 6. For this purpose, these tools 7, 8 are clamped on carrier plates 9 and 10, which may each be displaced individually in relation to the carriage 6 with the aid of actuating cylinders 11 and 12. While the actuating cylinder 11 engages on two lateral yokes 13, which are connected via armatures 14 which penetrate the carrier plate 10, as can be inferred from FIG. 1, the actuating cylinder 12 provided between the actuating cylinders 11 engages on a yoke 15 which has a drive connection to the carrier plate 1.

In addition to the tools 7, 8, which are adjustable in the axial direction, jaw tools 16, 17 are associated with the module 1, which form the individual tool jaws and can be applied with the aid of actuators 18 provided in the framework 4. For this purpose, guides 19 for clamping plates 20, which are radially opposite to one another in relation to the pipe ends 2, are provided in the framework 4, on which the actuators 18 engage and which detachably receive the jaw tools 16, 17. For this purpose, the jaw tools 16, 17, which are assembled into a handling unit, are provided with bolt attachments 21, which engage in detent recesses 22 of the clamping plates 20 and may be locked within these detent recesses 22. The locking drives are designated by 23.

In order that the jaw tools 16, 17 may be removed from the framework 4 with the module 1, the module 1 is equipped with a mount 24 for the jaw tools 16, 17 detached from the clamping plates 20. This mount 24 comprises two bar-type carriers 25, which are mounted so they are displaceable in carriages 6 parallel to the displacement guide 5 and may be applied in pairs with the aid of actuating cylinders 26. The carriers 25, which penetrate the carrier plates 9 and 10 so they are displaceable, engage with their ends protruding toward to the jaw tools 16, 17 in corresponding receptacle recesses of the jaw tools 16, 17, so that the jaw tools 16, 17 received by the carriers 25 may be extended with the carriage 6 out of the device.

The individual plastic pipes 3 are supplied one after another to the individual units, which are arrayed adjacent to one another and each form a module 1, for heating the pipe ends 2 and for widening the heated pipe ends 2 to form sockets, with the aid of a transverse conveyor 27, which is constructed from carriages 28 associated with the individual modules 1, which may be moved along a transverse guide 29 and have jaw tappets 30 for the individual plastic pipes 3. These jaw tappets 30, which are provided with individual tappet jaws 23 for the plastic pipes 3, are detachably connected to a lift drive 31, which comprises a guide 32 for a coupling unit 33 and an actuator 34, so that the jaw tappets 30 connected via the coupling unit 33 to the actuator 34 may be radially fed toward the plastic pipes 2 transversely to the transverse guide 29. The coupling of the jaw tappets 30 to the coupling unit 33 is performed in a similar way as the coupling of the jaw tools 16, 17 to the clamping plates 20 with the aid of bolt attachments 35. Because the plastic pipes 3 rest on a table 36 according to FIG. 3 and are displaced on this table 36 with the aid of the infed jaw tappets 30, jaw tappets 30 are only required on the side of the plastic pipes 3 facing away from the table 36.

The carriers 25 for the jaw tools 17 on the side of the pipe ends 2 facing away from the table 36 have a stroke which allows the carrier ends to advance through the jaw tools 17 up into corresponding receptacle recesses in the jaw tappets 30. It is thus possible to also receive the jaw tappets 30 detached from the actuator 31 by the mount 24 and to move them with the carriage 1 out of the framework 4.

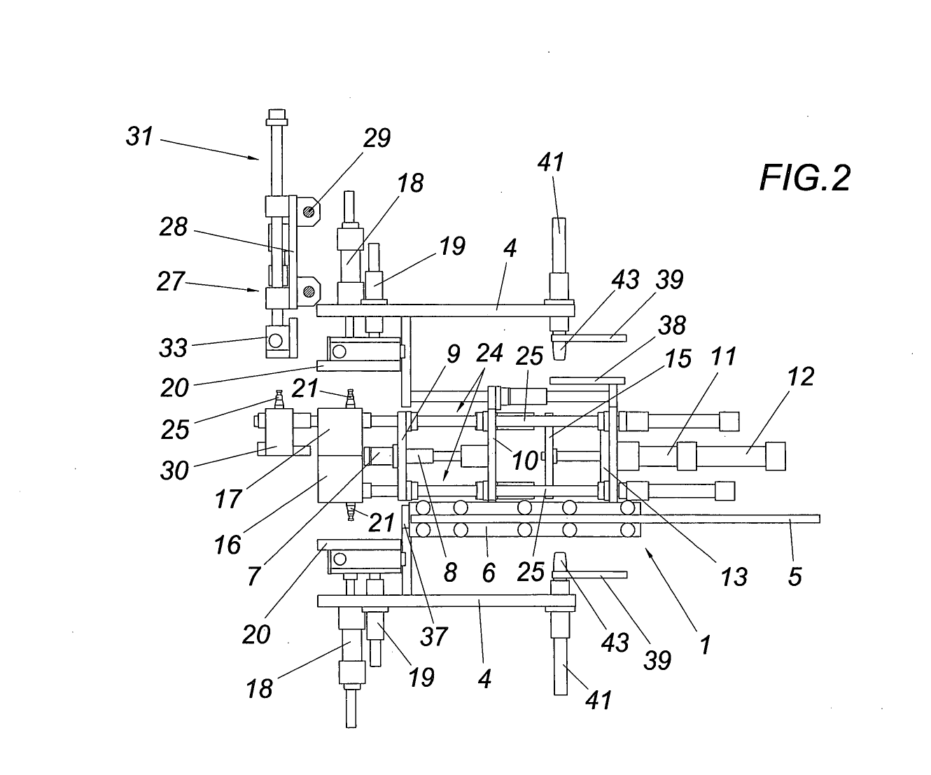

A starting position of the module 1 for the placement of a new processing unit in the framework 4 is shown in FIG. 1. The carriage 6 having the jaw tools 16, 17 carried by the mount 24 and the jaw tappets 30 is retracted into the framework 4 until the carriage 6 can be supported on stops 37, as shown in FIG. 2. In the operating position thus provided, the coupling parts 38 and 39 of a plug coupling 40, which are associated, on the one hand, with the module 1 and, on the other hand, with the framework 4, align with one another, so that the coupling part 39, which is guided so it is displaceable in the framework 4 and can have an actuator 41 applied to it, can be displaced toward the associated coupling part 38 on the side of the module 1 to couple the control and supply lines. Because the coupling part 39 carries locking bolts 43 which engage in detent recesses 42 of the coupling part 38, the carriage 6 is also automatically locked in its usage position with the coupling of the control and supply lines. Because, in the usage position of the carriage 6 in a corresponding terminal location of the actuating cylinder 26, the jaw tools 16, 17 and the jaw tappets 30 are held oriented in relation to the clamping plates 20 and/or the coupling 33, by appropriate application of the actuators 18 and 31, the jaw tools 16, 17 and the jaw tappets 30 may be connected to the associated actuators 18 and 31, the bolt attachments 21 of the jaw tools 16, 17 being locked in the associated detent recesses 22 of the clamping plates 20 and the bolt attachments 35 of the jaw tappets 30 being locked in the coupling unit 33. After the carrier 25 is retracted via the actuating cylinder 26, the processing unit formed by the particular module is ready for use, as can be inferred from FIG. 3.

To change the modules 1 arrayed adjacent to one another in the framework 4, only one of which for socket production is shown, because the other modules 1 used for heating the pipe ends, for example, have a fundamentally comparable construction, in reverse sequence, firstly the jaw tappets 30 and the jaw tools 16, 17 must be displaced into a predetermined transition position, which is preferably formed by the closed position of the jaw tools 16, 17, before the jaw tools 16, 17 and the jaw tappets 30 may be accepted by an application of the cylinder 26, in order to be able to extend the carriage 6 out of the framework 4 after opening of the plug coupling 40.

1. A device for implementing a socket on an end of crosscut plastic pipes, having a framework, having a transverse conveyor for the plastic pipes, having at least two units which are situated along the transverse conveyor in the framework, on the one hand, for heating the pipe ends and, on the other hand, for widening the heated pipe ends to form a socket, the units having jaw tools which externally enclose the pipe ends, which can be fed transversely to the conveyance direction with the aid of actuators mounted in the framework, and having at least one tool which is axially insertable into the pipe ends for at least one of the units, wherein the units form interchangeable modules (1), which are mounted so they are displaceable in the axial direction in the framework (4), and which comprise mounts (24) for the jaw tools (16, 17), which are detachable from their actuators (18), and, with the exception of actuators (18) for the jaw tools (16, 17), comprise all of the particular tools (7, 8) and drives (11, 12) associated with these units.

2. The device according to claim 1, wherein the modules (1) are implemented as carriages (6) which are movable in the framework (4).

3. The device according to claim 1, wherein the mount (24) for the jaw tools (16, 17) has carriers (25), which are mounted so they are displaceable parallel to the pipe axes and engage in receptacle recesses of the jaw tools (16, 17).

4. The device according to claim 3, wherein the mutual spacing of the carriers (25) measured in the direction of the feed of the jaw tools (16, 17) is equal to the corresponding spacing of the receptacle recesses of the closed jaw tools (16, 17).

5. The device according to claim 1, wherein the modules (1) each have a coupling part (38) of a plug coupling (40) for the control and supply lines of the tools (7, 8) and their drives (11, 12) of the particular unit, which works together with a coupling part (39) associated with the framework (4).

6. The device according to claim 5, wherein the coupling parts (39) of the plug couplings (40) associated with the framework (4) are mounted so they are adjustable transversely to the displacement guide (5) of the modules (1) and are provided with locking bolts (43), which engage in detent recesses (42) in the coupling parts (38) of the modules (1).

7. The device according to claim 1, wherein the transverse conveyor (27) comprises carriages (28), which are associated with the individual units and are movable along a transverse guide (29), and which carry jaw drivers (30), which can be fed transversely to the transverse guide (29) on the plastic pipes, and the modules (1) have a mount (24) for the jaw drivers (30), which are detachable from their actuators (31).

8. The device according to claim 3, wherein the carriers (25) penetrate the jaw tools (16, 17) in the receptacle recesses and engage in receptacle recesses of the jaw drivers (30).
